(19) United States
(12) Patent Application Publication
(10) Pub. No.: US 2007/0145195 A1
(43) Pub. Date: Jun. 28, 2007

(54) Deployable array support structure

(75) Inventors: Mark W. Thomson, Ventura, CA (US); Steve P. McMahon, Carpinteria, CA (US); Peter B. Laraway, Santa Barbara, CA (US); Steve Davis, Ventura, CA (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Northrop Grumman Space & Mission Systems Corporation

(21) Appl. No.: 11/640,015

(22) Filed: Dec. 15, 2006

Related U.S. Application Data
(60) Provisional application No. 60/756,140, filed on Jan. 4, 2006.
(60) Provisional application No. 60/753,953, filed on Dec. 23, 2005.

(51) Int. Cl. B64G 1/22

(52) U.S. Cl. 244/172.6

(57) ABSTRACT

A truss structure for a panel array includes a plurality of deployed bays. The plurality of deployed bays in a first side and an opposing second side. Each side includes a first upper horizontal support member attached to a first vertical support member and collapsible on a first joint translating on a second vertical support member. A first lower horizontal support member is attached to the second vertical support member and collapsible on a second joint translating on the first vertical support member.

### RELATED APPLICATIONS

The present invention claims priority from U.S. Provisional Patent Application No. 60/756,140, filed Jan. 4, 2006 and U.S. Provisional Patent Application No. 60/753,953, filed Dec. 23, 2005.

This invention was made with Government support under Contract No. NAS 7-1407. The Government has certain rights in this invention.

### TECHNICAL FIELD

The present invention relates to a deployable array, and, more particularly, to a deployable array support structure for a satellite.

### BACKGROUND

Space satellites often include a foldable panel array comprised of a plurality of flat panels, such as solar panels or antenna panels. The individual panels can each have a planar front or active surface upon which planar functional components, such as solar cells, reflectors, or antenna elements, are mounted. The active surfaces of the panels are desirably maintained smooth and unmarred by any projections, which tend to degrade the performance of the panels. Toward this end, any hardware devices, such as structural supports and hinge mechanisms, are desirably mounted on a rear surface of the panels so that they do not interfere with the planarity of the active surfaces.

The panel array may be maintained in a stowed or folded state wherein the individual panels are folded over one another in an accordion-like fashion. In the folded state, the surface of one panel is juxtaposed with a surface of an adjacent panel so that the panels are stacked atop one another and the panel array consumes less space. The panel array is preferably maintained in the folded state prior to use and also during launch of the spacecraft in order to conserve cargo space within the spacecraft launch vehicle.

The panel array transitions to a deployed or extended state after the satellite reaches orbit. In the deployed state, the individual panels are disposed in an edge-to-edge fashion such that the active surfaces of the panels are aligned in a common plane. The active surfaces of the individual panels thereby collectively form an enlarged active surface for the panel array.

### SUMMARY

The present invention relates to a truss structure of a panel array. The truss structure includes a plurality of deployed bays. The bays include a first side and an opposing second side. Each side of a deployed bay comprises a first upper horizontal support member attached to a first vertical support member and collapsible on a first joint translating on a second vertical support member. A first lower horizontal support member is attached to the second vertical support member and collapsible on a second joint translating on the first vertical support member.

In accordance with an aspect of the invention, each bay further comprises a plurality of substantially parallel cross-support members extending substantially orthogonal to the vertical support members and the horizontal support members. The plurality of cross-support members connect opposing sides of each bay of the truss structure.

In accordance with another aspect of the invention, the cross-support members include a plurality of lower cross-support members. The plurality of lower cross-support members connect lower ends of vertical supports on the first side with lower ends of vertical supports on the second side. The cross-support members also include a plurality of upper cross-support members. The upper cross-support members connect upper horizontal support members on the first side with upper horizontal support members on the second side. The upper cross-support members support a plurality of panels.

In accordance with a further aspect of the invention, the truss structure can comprise a third vertical support member. A second upper horizontal support member can be attached to the third vertical support member and be collapsible on the first joint translating on the second vertical support member. A second lower horizontal support member can be attached to the second vertical support member and be collapsible on a third joint translating on the third vertical support member.

The first vertical support member can be shared between a first deployable bay adjacent to a second deployable bay. The third vertical support member can be shared between the second deployable bay and an adjacent third deployable bay. The first, second, and third deployable bays are included in the plurality of deployable bays.

In accordance with another aspect of the invention, each deployable bay comprises a telescoping strut connecting the first vertical support and the second vertical support, a first end of the telescoping strut being attached to an upper end of the first vertical support and a second end of the telescoping strut can be connected to a lower end of the second vertical support.

In accordance with yet another aspect of the invention, the first upper horizontal support member and the first lower horizontal support member can be hollow. The truss structure can include at least one deployment cable routed through the first upper horizontal support member and at least one synchronization cable routed through the first lower horizontal support member.

The present invention also relates to a truss structure for a panel array that comprises a plurality of deployed bays. The plurality of deployed bays include a first side and an opposing second side. The each side of the deployed bays include at least first, second, and third vertical support members delineating a first bay and a second bay. The second vertical support member is shared between the first bay and second bay. The first bay includes a first upper horizontal support member attached to the first vertical support member and collapsible on a first joint translating on the second vertical support member. A first lower horizontal support member is attached to the second vertical support member and collapsible on a second joint translating on the first vertical support member. The second bay includes a second upper horizontal support member attached to the third vertical support member and collapsible on the first joint translating on the second vertical support member. A second lower horizontal support member attached to the second vertical support member and collapsible on a third joint translating on the third vertical support member.

In accordance with another aspect of the invention, each bay can include a plurality of substantially parallel cross-support members extending substantially orthogonal to the vertical support members and the horizontal support members. The plurality of cross-support members can connect opposing sides of bays of the truss structure.

In accordance with another aspect of the invention, the cross-support members include a plurality of lower cross-support members. The plurality of lower cross-support connect lower ends of vertical supports on the first side with lower ends of vertical supports on the second side. The cross-support members also include a plurality of upper cross-support members. The upper cross-support members connecting upper horizontal support members on the first side with upper horizontal support members on the second side. The upper cross-support members support a plurality of panels.

In a further aspect of the invention, the first deployable bay can include a first telescoping strut connecting the first vertical support member to the second vertical support. A first end of the telescoping strut is attached to an upper end of the first vertical support and a second end of the telescoping strut is connected to a lower end of the second vertical support. The second deployable bay can also comprise a telescoping strut connecting the second vertical support to the third vertical support. A first end of the second telescoping strut can be attached to a lower end of the second vertical support and a second end of the second telescoping strut being connected to a upper end of the third vertical support.

In accordance with yet another aspect of the invention, the truss structure can further comprise first and second pulleys riding with the first joint, a third pulley at a first end of the second vertical support member, a fourth pulley at a first end of the third vertical support member, and a fifth pulley at a first end of the first vertical support member. A deployment cable can run over the third, fourth, and fifth pulleys and under the first and second pulleys. The truss structure can also include a winding motor for pulling in the deployment cable to lift the first joint into a deployed position.

The truss structure can further include a sixth pulley riding with the second joint, seventh and eighth pulleys adjacent to a second end of the second vertical support member, and a ninth pulley riding with the third joint.

In yet another aspect of the invention, the truss structure can include at least one lanyard for maintaining the bays in tension during deployment. The lanyard can extend the length of each side.

### BRIEF DESCRIPTION OF THE DRAWINGS

FIG. 1 illustrates a schematic perspective view of a panel array of a satellite in accordance with an aspect of the invention.

FIG. 2 illustrates a schematic perspective view of a truss section of the panel array of FIG. 1 in accordance with another aspect of the invention.

FIG. 3 illustrates a schematic perspective view of the truss section of FIG. 2 in a partially deployed (or collapsed) configuration in accordance with an aspect of the invention.

FIG. 4 illustrates a schematic perspective view of the truss section of FIG. 2 in a fully collapsed configuration.

FIG. 5 illustrates a schematic perspective view of a panel array in collapsed configuration attached to a satellite in accordance with an aspect of the invention.

FIG. 6 illustrates a schematic perspective view of the panel array of FIG. 5 stowed in a storage chamber of a launch vehicle in accordance with an aspect of the invention.

FIG. 7 illustrates a schematic perspective view of a first bay and a second bay of a truss section of a panel array in accordance with another aspect of the invention.

FIG. 8 illustrates a schematic perspective view of a truss section in a collapsed configuration in accordance with another aspect of the invention.

FIG. 9 illustrates a schematic perspective view of a translating joint of a truss section in a partially deployed configuration in accordance with an aspect of the invention.

FIG. 10 illustrates a schematic perspective view of the translating joint of the truss section of FIG. 9 in accordance with another aspect of the invention.

FIG. 11 illustrates a schematic perspective view of a fixed joint of a truss section in accordance with an aspect of the invention.

FIG. 12 illustrates a schematic perspective view of a deployment cable scheme and synchronizer cable scheme of one side of a truss structure in accordance with an aspect of the invention.

FIG. 13 illustrates a schematic perspective view of a partially deployed truss section in accordance with another aspect of the invention.

FIG. 14 illustrates a schematic perspective view of a panel array in a collapsed configuration in accordance with another aspect of the invention.

FIG. 15 illustrates a schematic perspective view of the panel array of FIG. 14 with a partially deployed truss section.

FIG. 16 illustrates a schematic perspective view of the panel array of FIG. 14 with fully deployed truss section.

FIG. 17 illustrates a schematic perspective view of the panel array of FIG. 14 fully deployed in accordance with an aspect of the invention.

### DETAILED DESCRIPTION

The present invention relates to a folding truss structure suitable for deployment in outer space. The folding truss structure can be used to support a beam type structure, such as an electronically scanned array panel for large azimuth scanning radars that includes a plurality of flat panels. The panel array is movable between a folded state and a deployed or extended state. In the folded state, the panels are folded over one another in a juxtaposed relationship so that the panels can be stowed in a face-to-face and back-to-back relation without need for significant truss structure there between. In the extended state, the panels are aligned edge-to-edge such that the front or active surfaces of the panels are disposed within a common plane.

The folding truss structure occupies less stowed volume than previous folding truss structures and uses translating joints to allow the truss structure to collapse into a volume much smaller than previous truss structures. The truss structure can self-deploy without needing an additional deployment structure to maximize the efficiency of the resulting deployable structure.

The truss structure can also include at least one tension line or lanyard that controls the deployment rate of the truss structure and maintains stiffness in the truss structure throughout deployment. The stiffness of the structure can be maintained by differential tensioning of at least one lanyard during deployment. Upon deployment, the lanyards can also be differentially tensioned to provide the truss structure with a substantially linear shape.

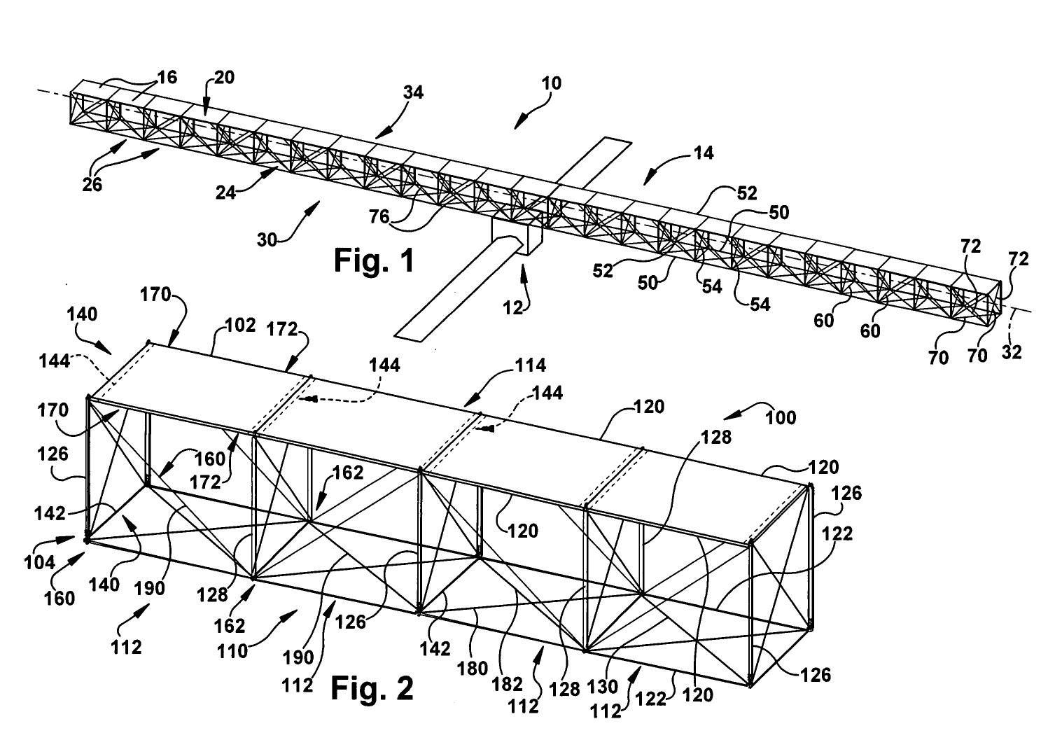

FIG. 1 illustrates a schematic perspective view of a satellite 10 that includes a main body 12 and a panel array 14 attached thereto. The panel array 14 includes a plurality of flat panels 16 that are arranged edge-to-edge in a substantially linear configuration to form a substantially planar array surface 20. The panel array 14 can form, for example, a large azimuth electronically scanned array (e.g., phased or corporate fed), a solar panel array, an antenna array, or another system, which requires deployment of a panel array from a stowed configuration to a deployed configuration. The flat panels 16 of the panel array 14 are supported in linear configuration by a foldable truss structure 24.

The truss structure is foldable 24 from a collapsed configuration to a fully deployed substantially linear configuration. The truss structure 24 is divided into repeating rectangular structures or subdivisions referred to herein as bays 26. The bays 26 include a first side 30 and second side 34 that extend along an axis 32 of the truss structure 24. The second side 34 is separated from and extends substantially parallel to the first side 30. The first side 30 and the substantially parallel second side 34 extends substantially perpendicular to the panel array surface 20.

The bays 26 include lower horizontal support members 50, upper horizontal support members 52, and vertical support members 54. The horizontal and vertical support members 50, 52, and 54 are present in a repeating pattern in each of the first side 30 and the second side 34 to form the bays 26, with adjacent bays 26 sharing a common vertical support member 54. The vertical support members 54 in deployed configuration extend substantially perpendicular to the panel array surface 20 and the axis 32.

The bays 26 further includes a plurality of cross-support members 60 that connect vertical support members 54 in the first side 30 and the second side 34 of the bays 26. The plurality of cross-support members 60 extend substantially parallel to one another and substantially orthogonal to the vertical support members 54, the horizontal support members 50 and 52, and the axis 32.

The horizontal support members 50 and 52, vertical support members 54, and cross-support members 60 can be hollow and formed using a low Coefficient of Thermal Expansion (CTE) material. For example, a reinforced graphite resin system may be used to form the support members 50, 52, 54 and 60. It will be appreciated that other materials can also be used to form the support members 50, 52, 54, and 60, such as metal (e.g., titanium and aluminum).

The bays 26 further includes cross-connected tension members 70 and 72 and diagonal telescoping struts 76. The tensions members 70 and 72 and diagonal telescoping struts 76 provide, upon deployment of the truss structure 24, stability for the horizontal support members 50 and 52 and vertical support members 54. Each diagonal member stabilizes the six sides of each bay. This is desirable since the horizontal support members 50 and 52 and the vertical support member 54 pivot at their ends and thus on their own can provide no in-plane sheer stiffness. The tension members 70 may be formed from unidirectional graphite filamentary lines and the diagonal telescoping struts can be formed using low CTE material, such as a CTE material used to form the horizontal support members 50 and 52 and/or vertical support members 54.

FIG. 2 illustrates a portion 100 of the panel array 10 of FIG. 1. The portion 100 of the panel array 10 comprises four panels 102 that are supported by a truss section 104 of the truss structure 24 (FIG. 1). The truss section 104 includes four deployed bays 112, each having substantially the same size, with an opposing first side 110 and an opposing second side 114. The side of each bay 112 includes an upper horizontal support member 120, a lower horizontal support member 122, two vertical support members 126 and 128, and a telescoping strut 130. It will be appreciated that adjacent bays 112 share a vertical support member 126 or 128. The sharing of vertical support members 126 or 128 continues in this fashion between adjacent bays 112.

A plurality of cross-support members 140 connect opposing sides 110 and 114 of the bays 112. The plurality of cross-support members include a plurality of lower cross-support members 142 and a plurality of upper cross-support members 144. The plurality of lower cross-support 142 connect lower ends 160 and 162 of, respectively, the vertical support members 126 and 128 of the first side 110 with lower ends 126 and 128 of, respectively, the vertical support members 126 and 128 of the second side 114 of the bay 112. The plurality of the upper cross-support members 144 connect first and second ends 170 and 172 of the upper horizontal support members 120 of the first side 110 with first and second ends 170 and 172 of the upper horizontal support members 120 of the second side 114. The plurality of upper support members 144 support the panels 102 in the panel array.

Cross-connected tension members 180 and 182 can be provided between opposing vertical supports 126 or 128 and opposing horizontal supports 120 or 122 in the bays 112 to stabilize and provide stiffness to the truss section 100. The cross-connected tension members 180 and 182 can include, for example, graphite fiber cords, pultruded rods, and/or cables.

Telescoping struts connect the vertical support members 126 and 128 in each bay 112. The telescoping struts are extendable from a collapsed configuration when the panel array 14 is stowed to an extended configuration when the panel array is deployed. The telescoping struts are pivotably attached to the vertical supports 126 and 128 and can include a latching means (not shown) that locks the telescoping strut in an extended position during panel array 14 deployment.

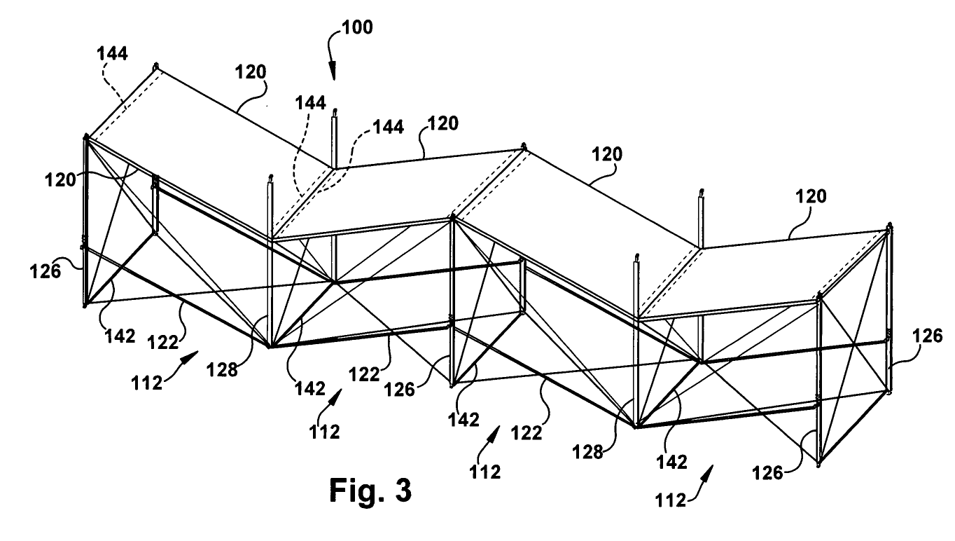

FIG. 3 shows the truss section 100 partially deployed (unlike the full deployment illustrated in FIG. 2) with the bays 112 in a partially collapsed (or deployed) state. For reference purposes, the upper horizontal support members 120, the lower horizontal support members 122, the two vertical support members 126 and 128, upper cross-support members 144, and lower cross-support members 142 are labeled as in FIG. 3.

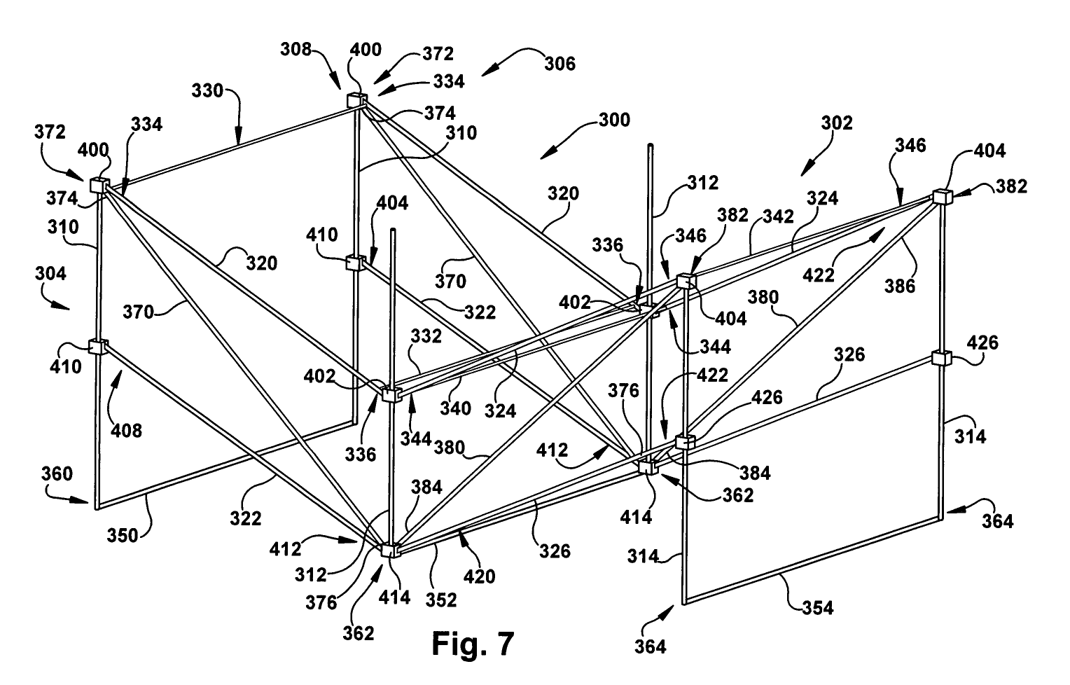

As will be discussed in more detail below with regard to FIGS. 7-10, translating joints and fixed pivoting joints allow the truss section 100 to collapse into a very compact volume. One significant factor in reducing the stowed volume is that the upper horizontal support members (e.g., the upper horizontal support member 120) are oriented on opposite sides of the vertical support members 126 or 128 as the lower horizontal support members (e.g., the lower horizontal support member 122). In other words, the upper and lower horizontal support members 120 and 122 are taken out of the plane of the vertical support members 126 or 128. The vertical support members 126 or 128 may then come extremely close together in the stowed position, allowing very volume efficient stowage of the truss structure and panel array.

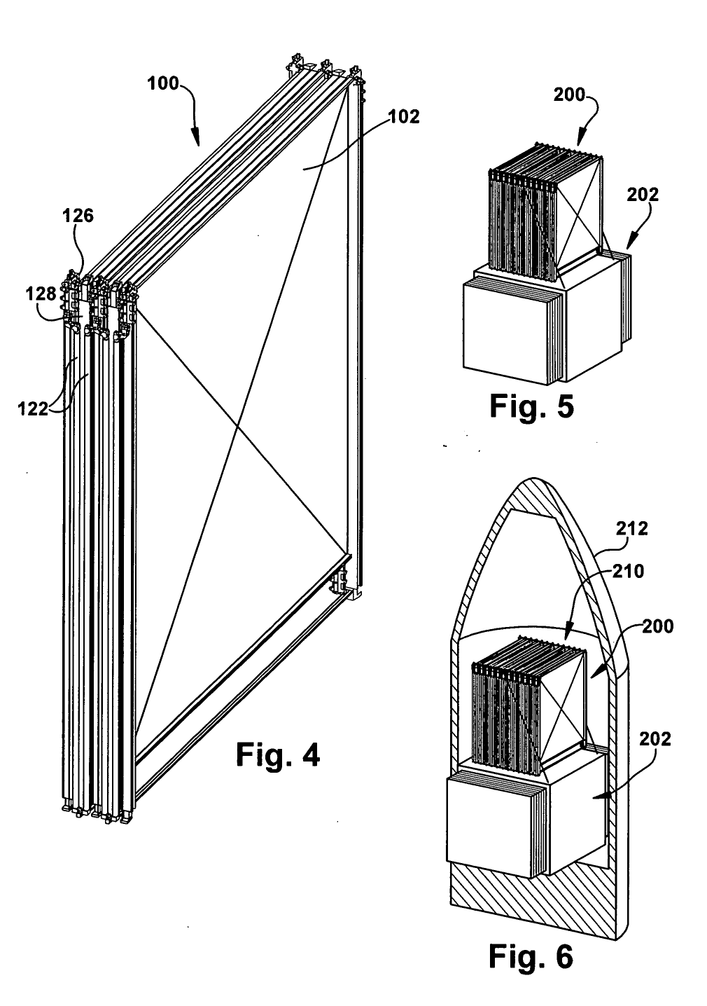

As the truss section collapses, the upper and lower horizontal support members 120 and 128 and telescoping strut 190 (as well as every other horizontal support member and panel) move toward a vertically oriented position when the perimeter truss section 100 is collapsed. The upper and lower horizontal support members 120 and 122 reach a vertical orientation when the truss section 100 is completely collapsed, as shown in FIG. 4.

In the collapsed state, the panels 102 are folded over one another in a juxtaposed relationship so that the panels 102 are provided in a face-to-face and back-to-back relation. The vertical support members 126 and 128 and horizontal members 120 and 122 are positioned about the perimeter of the panels 102 so that the panels 102 are stowed without any significant members impeding the maximum possible compaction ratio.

FIG. 5 illustrates that the panel array 200 in collapsed configuration can be secured to a spacecraft 202, such as a satellite. FIG. 6 illustrates the high compaction ratio of the panel array 200 allows the panel array 200 in the collapsed configuration to be readily stowed in a stowage compartment 210 of a launch vehicle 212, e.g., Delta IV rocket, without the use of a deployment canister.

Referring again to FIG. 3, the bays 112 may be restored by opening the truss section. The mechanism by which the horizontal support members 120 and 122 allow the bays 112 to collapse and expand is illustrated in greater detail in FIG. 7.

FIG. 7 illustrates a first bay 300 and a second bay 302 of a truss structure 306 in a partially collapsed (or deployed) form. The first bay 300 and the second bay 302 include a first side 304 and an opposing substantially parallel second side 308. The left and right ends of the first bay 300 are defined, respectively, by first vertical support members 310 and second vertical support members 312. The left and right ends of the second bay 302 are defined, respectively, by the second vertical support members 312 and third vertical support members 314. The top and bottom sides of the first bay 300 are defined by, respectively, first upper horizontal support members 320 and first lower horizontal support members 322. Similarly, the top and bottom sides of the second bay 302 are defined by, respectively, second upper horizontal support members 324 and second lower horizontal support members 326.

A first upper cross-support member 330 and a second upper cross-support member 332 connect the first upper horizontal support member 320 of the first side 304 with the first upper horizontal support member 320 of the second side 308. The first upper cross-support member 330 extends substantially orthogonal to and between left ends 334 of the first upper horizontal support members 320, and the second upper cross-support member 332 extends substantially orthogonal to and between the right ends of the first upper horizontal support members 320.

A third upper cross-support member 340 and a fourth upper cross-support member 342 connect the second upper horizontal support member 324 of the first side 304 with the second upper horizontal support member 324 of the second side 308. The second upper cross-support member 340 extends substantially orthogonal to and between left ends 344 of the second upper horizontal support members 324, and the second upper cross-support member 342 extends substantially orthogonal to and between the right ends 346 of the second upper horizontal support members 324.

A first lower cross-support member 350, a second lower cross-support member 352, and a third lower cross-support member 354 connect, respectively, the first, second, and third vertical support members 310, 312, and 314. The first, second, and third cross-support members 350, 352, and 354 extend substantially orthogonal to and between lower ends 360, 362, and 364 of the first, second, and third vertical support members 310, 312, and 314.

The first and second cross-support members 330 and 332 and the third and fourth cross-support members 340 and 342 support, respectively, first and second panels (not shown) of the panel array. The first and second panels can be flat. Each panel can include a first substantially flat surface and a second spaced apart and substantially parallel flat surface. The first surface can face and abut the cross-support members. The second surface can face away from the first surface and define an active surface of the panels.

First telescoping struts 370 connect the first vertical support members 310 to the second vertical support members 312. The first telescoping struts 370 are extendable from a collapsed configuration when the panel array 14 is stowed to an extended configuration during panel array deployment. The first telescoping struts 370 extend from the upper ends 372 of the first vertical support members 310 to, respectively, the lower ends 362 of the second vertical support members 312. The first telescoping struts 370 have first ends 374 and second ends 376 that are pivotably attached to, respectively, the upper ends 372 and the lower ends 376.

Second telescoping struts 380 connect the second vertical support members 312 to the third vertical support members 314. The second telescoping struts 380, like the first telescoping struts 370, are extendable from a collapsed configuration when the panel array 14 is stowed to an extended configuration during panel array deployment. The second telescoping struts 380 extend from the lower ends 362 of the second vertical support members 312 to, respectively, upper ends 382 of the third vertical support members 314. The second telescoping struts 380 have first ends 384 and second ends 386 that are pivotably attached to, respectively, the lower ends 362 and the upper ends 382.

The left ends 334 of the first upper horizontal support members 320 are pivotably attached to, respectively, fixed joints 400 provided on the upper ends 372 of the first vertical support members 310 by, for example, pivot pin members (not shown). The right or opposite ends 336 of the first upper horizontal support members 320 are pivotably attached to, respectively, translating joints 402 coupled the second vertical support member 312 using, for example, pivot members (not shown). In a similar fashion, left ends 344 of the second upper horizontal support members 324 are attached to, respectively, the translating joints 402 using, for example, pivot members (not shown). Opposite or right ends 346 of the second upper horizontal support members 324 are pivotably attached to fixed joint 404 provided on the upper ends 382 of the third vertical support members 314 using, for example, pivot members (not shown).

Left ends 408 of the first lower horizontal support members 322 are pivotably attached to translating joints 410 coupled to the first vertical support member 310 using, for example, a pivot member (not shown). The right ends 412 of the first lower horizontal support members 322 are pivotably attached to fixed joints 414 provided on the lower ends 362 of the second vertical support members 312 using, for example, pivot members. In a similar fashion, left ends 420 of the second lower horizontal support members 326 are attached to the fixed joints 414. Opposite or right ends 422 of the second lower horizontal support member 326 are pivotably attached to, respectively, translating joints 426 coupled to the third vertical support member 314.

The pattern of translating (or sliding) joints and fixed joints repeats regularly along first side 304 and the second side 308 of each adjacent bay. Thus, there is a translating joint on every other vertical support member for the upper horizontal support members that alternates with a fixed joint on every other vertical support member for the upper horizontal support members. Similarly, there is a sliding joint on every other vertical support member for the lower horizontal support members that alternates with a fixed joint on every other vertical support member for the lower horizontal support members. Where an end of an upper horizontal support member attaches to a sliding joint, the corresponding end of a lower horizontal support member attaches to a fixed joint.

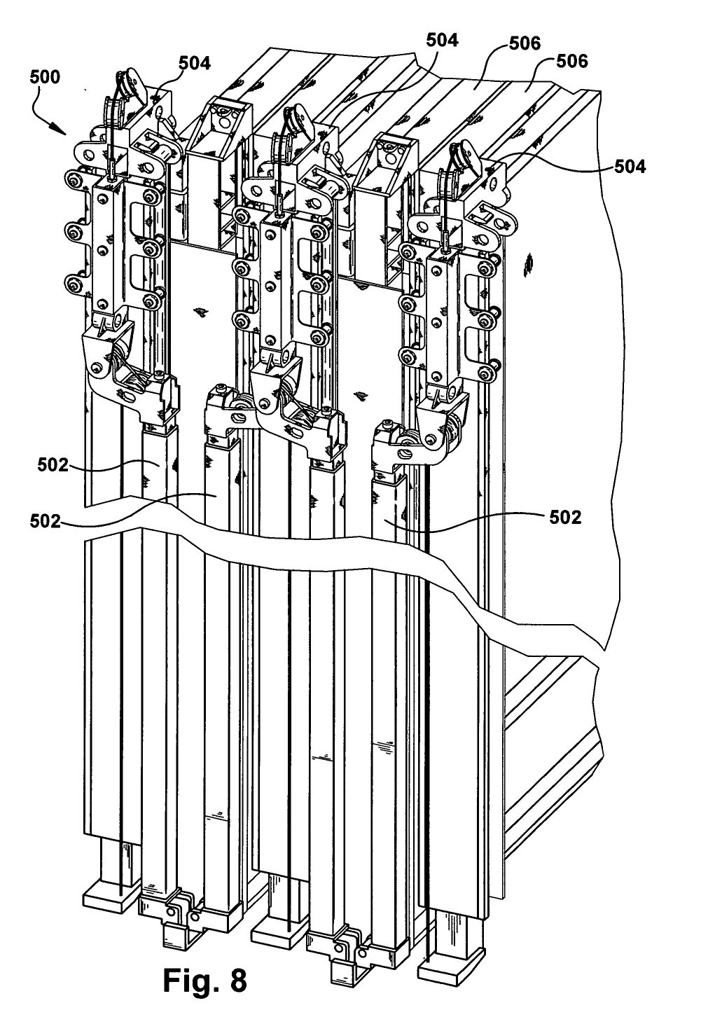

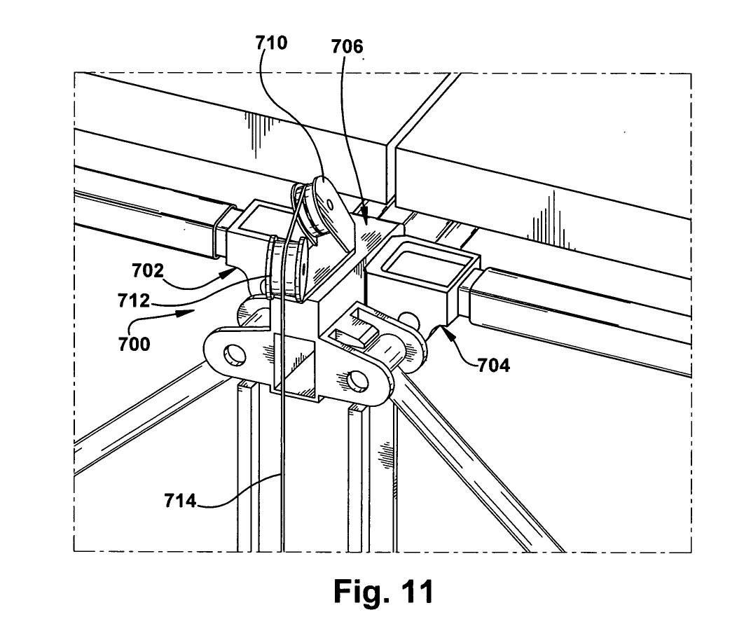

The translating joints 402, 410, and 426 provide linear motion along their respective vertical support members 312, 310, and 314. It will therefore be appreciated that the translating joints 402, 410, and 426 may be implemented as sliding joints (e.g., as a larger tube wrapped around its corresponding vertical support member 312, 310, and 314). Alternatively, the translating joints 402, 410, and 426 may be implemented by forming rails along the vertical support members 312, 310, and 314 and providing wheels for the sliding joint structure to allow translation along the rails. A translating joint having such a construction is illustrated in more detail below in FIGS. 8-10. A fixed joint is illustrated in more detail in FIG. 11.

When the perimeter truss section 306 deploys, the ends of the horizontal support members attached to fixed joints pivot to follow the ends of the horizontal support members attached to the translating joints. Thus, for example, as the translating joints 402 moves toward the top of the vertical support members 312, the left end 334 of the first upper horizontal support members 320 allows the first upper horizontal support members 320 to pivot (or rotate) into a horizontal position.

The fixed joints 400 and 404 and the translating joints 402 (and indeed all joints for the upper horizontal support members) are oriented to face toward an interior of the truss section 306. The fixed joints 414 and the translating joints 410 and 426 are oriented to face the opposite direction, namely away from the interior of the truss section 306.

FIG. 8 illustrates a perspective view of a side of a collapsed truss section 500 of the truss structure. The truss section 500 shows that the lower horizontal support members 502 are disposed out of the plane of the vertical support members 504 away from the panels 506, while the upper horizontal support members (not shown) are disposed out of the plane of the vertical support members 504 toward the panels 506. Alternatively, the lower horizontal support members 502 may face the interior of the structure, while the upper horizontal support members face the exterior of the truss structure.

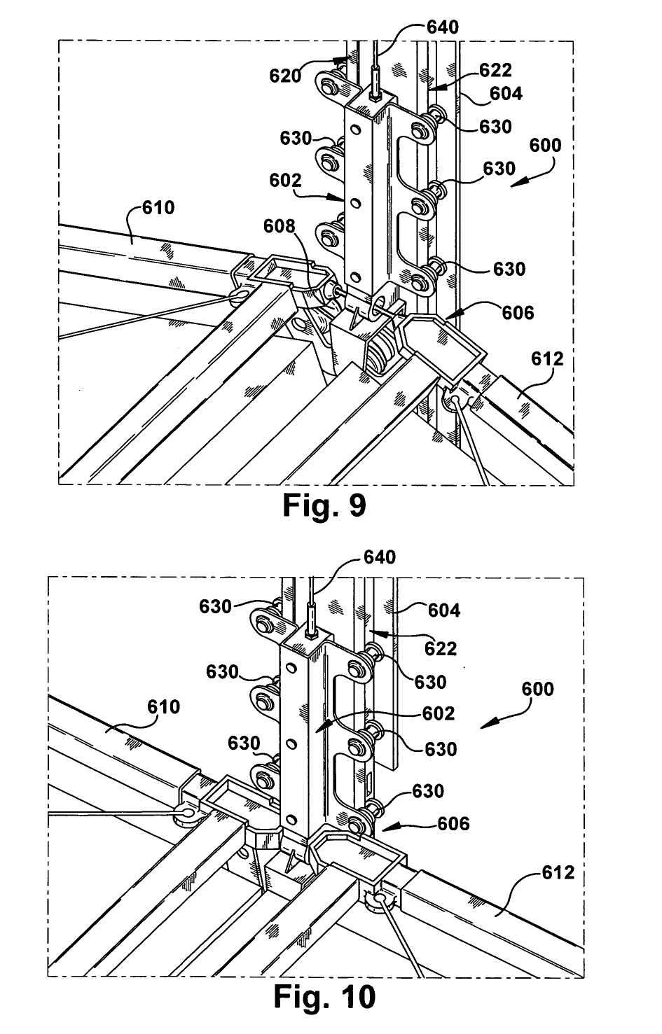

FIGS. 9 and 10, illustrate an embodiment of a joint and rail system 600 that may be used for a translating joint. The translating joint 600 includes a trolley 602 that couples to a vertical support member 604 and a bracket 606. The bracket includes a first pulley 608 and a second pulley (not shown) for deploying and positioning each of the horizontal support members 610 and 612. Each of the pulleys preferably rotates on ball bearings (not shown).

The vertical support member includes a left rail 620 and a right rail 622 to which the trolley 602 is movably coupled for translation movement along the vertical support member 604. The left rail 620 and the right rail 622 are substantially parallel and run substantially the length of the vertical support member 604. The trolley 602 includes six cupped wheels 630, three of which ride along, respectively, the left rail 620 and three of which ride along the right rail 622, to couple the trolley 602 to the vertical support member 604. The number of wheels 630 can be more or less and will depend on the particular structure of the trolley.

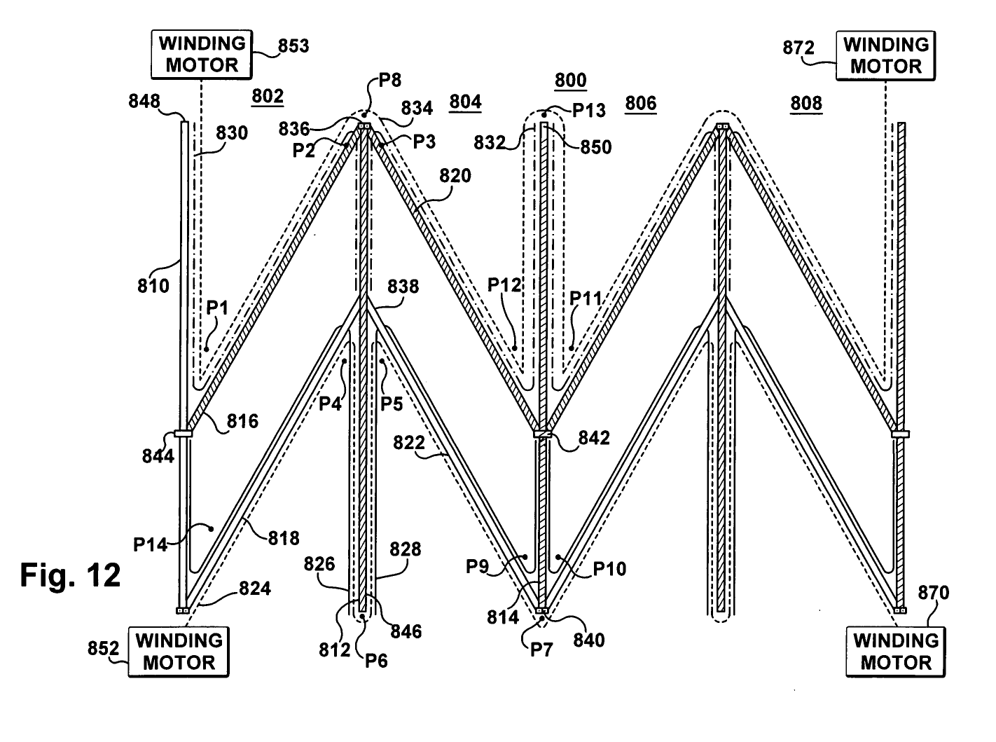

A deployment cable (not shown) for deploying the truss structure runs through the first horizontal support member 610 and over the first pulley 608. The deployment cable then continues down the vertical support member 604 where it runs over a pulley (not shown) and back down over the second pulley. The deployment cable then runs inside of the horizontal support member 612. The deployment cable is thus routed in the fashion described below with regard to the deployment cable in FIG. 12.

An optional synchronization cable 640 also attaches to the translating joint 600. The optional synchronization cable 640 may, for example, represent the synchronization cable described in more detail below in FIG. 12. When the deployment cable winds up, it exerts a force on the translating joint 600. The translating joint 600 therefore rolls along the left and right rails 620 and 622 to move along the vertical support member 604. The synchronization cable 640 can then pull down to apply a downward force on a translating joint shared between adjacent bays.

FIG. 11 shows a fixed joint 700 that is provided on an opposite end of the vertical support member as the translating joint 600. The fixed joint 700 includes a first pivot member 702 and a second pivot member 704 that are coupled to a vertical support member 706. The vertical support member 706 supports the fixed joint 700 and a pair of positioning pulleys 710 and 712 for the optional synchronization cable 714. The pulleys 710 and 712 allow the optional synchronization cable 714 to extend along the vertical support member 714.

FIG. 12 illustrates a side of a plurality of bays of a truss section 800 as well as the manner in which the deployment and synchronization cables run through the side and the perimeter truss structure 24 (FIG. 1) as a whole. The side includes four partially collapsed bays 802, 804, 806, and 808. Because the deployment and synchronization cables are routed symmetrically between the sides of the bays, the following discussion focuses only on the routing through the side of the first bay 802 and the second bay 804, but is applicable to all the bays 806 in the side as well as the opposing side of the bay of the perimeter truss structure.

The first bay 804 includes a first vertical support member 810 and a second vertical support member 812. The second bay 806 shares the second vertical support member 812 and also includes a third vertical support member 814. The first bay also includes a first upper horizontal support member 816 and a first lower horizontal support member 818. The second bay includes a second upper horizontal support member 820 and a second lower horizontal support member 822.

FIG. 12 shows the positioning of the deployment cable 824 as well as optional lower synchronization cables 826 and 828 and optional upper synchronization cables 830 and 832. A second deployment cable 834 is also illustrated. When sufficient guarantees of reliability exist, the truss structure may be opened with a single deployment cable (e.g., the deployment cable 824). The optional synchronization cables 826-832 and second deployment cable 834 provide a measure of protection against a broken deployment cable, as will be explained in more detail below.

Pulleys (or other rotating structures) are located where the deployment cables 824 and 834 and synchronization cables 826-832 turn. For example, pulleys are located approximately at the points labeled P1-P14 in FIG. 12. FIG. 12 exaggerates the turns in the cables for clarification. Thus, in reality, the pulleys P2, P3, and P8 are located closely together on a common fixed joint 836, the pulleys P4 and P5 are located closely together on a common translating joint 838. Similarly, the pulleys P7, P9, and P10 are located closely together on a common fixed joint 840, while the pulleys P11 and P12 are located closely together on a common translating joint 842. The pulleys P6 and P13 are attached at ends of the vertical support members 812 and 814.

With regard first to the deployment cable 824, it is noted that the deployment cable 824 can run through the lower horizontal support member 818, if hollow, or astride the member 818, over the pulley P4, and down the outside the vertical support member 812. The deployment cable 824 continues around the pulley P6, up the outside of the vertical support member 812, and over the pulley P5. The deployment cable 824 continues down the inside of (or astride) the second lower horizontal support member 822, under the pulley P7, and continues in the same fashion along the side of the truss structure.

The second deployment cable 834 can be routed through (or astride) the first upper horizontal support member 816, around the pulley P8, and through (or astride) the second upper horizontal support member 820. The second deployment cable 834 continues around the pulley P12 and up the outside of the vertical support member 814, around the pulley P13, and down the outside of the vertical support member 814. The second deployment cable 834 is routed around the pulley P11 and continues in the same fashion along the side of the truss structure.

The first lower synchronization cable 826 attaches to the translating joint 844 and runs down the outside of the vertical support member 810, around the pulley P14, and inside of or astride the first lower horizontal support member 818. The first lower synchronization cable 826 continues around the pulley P4 and down the outside of the vertical support member 812 to attach at the fixed joint 846. It is noted that where two or more cables make a common turn, a pulley may be provided for each cable. Thus, the pulley P4 may in fact be replaced by a pulley for the first synchronization cable 826 and a pulley for the deployment cable 824.

The second lower synchronization cable 828 is connected in a similar fashion. The second lower synchronization cable 828 attaches to the fixed joint 846, runs up the outside of the vertical support member 812, and around the pulley P5. The second lower synchronization cable 828 continues inside of (or astride) the second lower horizontal support member 822, around the pulley P9, and connects to the translating joint 842. The synchronization cables may be attached by threading their ends and coupling them into a joint.

The upper synchronization cables 830-832 are routed in a manner symmetric with the lower synchronization cables 826-828. In particular, the first upper synchronization cable 830 attaches to the fixed joint 848, runs down the outside of the vertical support member 810, and around the pulley P1. The first upper synchronization cable 830 continues up the inside of the first upper horizontal support member 816, around the pulley P2, and connects to the translating joint 838.

The second upper synchronization cable 832 attaches to the translating joint 838 and runs up the outside of the vertical support member 812, around the pulley P3, and down the inside of the second upper horizontal support member 820. The second upper synchronization cable 832 continues around the pulley P12 and up the outside of the vertical support member 814 to attach at the fixed joint 850.

In operation, winding motors 852 and 853 may be used to take-up (i.e., pull) the deployment cables 824 and 834 onto spools. When the deployment cable 824 pulls in, the deployment cable 824 exerts a downward force on the translating joint 838 (as well as all translating joints for the lower horizontal support members). When the deployment cable 834 pulls in, the deployment cable 834 exerts an upward force on the translating joint 842 (as well as all translating joints for the upper horizontal support members). The downward and the upward force begins to push the perimeter truss structure apart.

Assuming, for example, that the second deployment cable 834 is broken, the upper synchronization cables 830 and 832 (which are coupled to the translating joint 838), are pulled down at their 838 end, thereby exerting an upward force on the translating joints 842 and 844. Synchronism in the deployment of the upper and lower portions of the perimeter truss structure is thereby maintained.

A similar situation exists when the deployment cable 824 is broken. In this situation, the lower synchronization cables 826-828 are pulled up by the translating joints 842 and 844 due to the pulling in of the second deployment cable 834. As a result, the lower synchronization cables exert a downward force on the translating joint 838 to maintain deployment synchronism with the upper portion of the truss structure.

A single deployment cable (e.g., 824 or 834) is sufficient to pull the entire side of the truss structure into deployment because the force it exerts is coupled through the perimeter truss structural members to the translating joints 842 and 844 as well. The deployment cables 824 and 834 and synchronization cables 826-832 may be formed from a high modulus, high tensile fiber, such as Kevlar or steel cables. As a result, the pulleys may be quite small, thereby reducing the size, weight, and cost of the truss structure 24 (FIG. 1).

With reference again to FIG. 2, it is noted that as the truss structure comes to final deployment, the upper horizontal support members of the first side are aligned are aligned parallel to the upper horizontal support members of the second side so as position the panels of the panel array in a substantially flat and linear configuration as illustrated in FIG. 1.

Optionally, additional winding (or deployment) motors 870 and 872 may be used to take-up (i.e., pull) the deployment cables 824 and 834 onto spools. The winding motors can be connected to opposite ends of, respectively, deployment cables 824 and 834. The winding motors 870 and 872 provide reliability redundancy of the primary winding motors 852 and 853 and the ability to overcome frictional losses as the number of deployment cable runs (turns) over pulleys increases with the length of the truss and increased number of bays. The winding motors 870 and 872 can also be used to divide the amount of force required to deploy the truss in longer configurations.

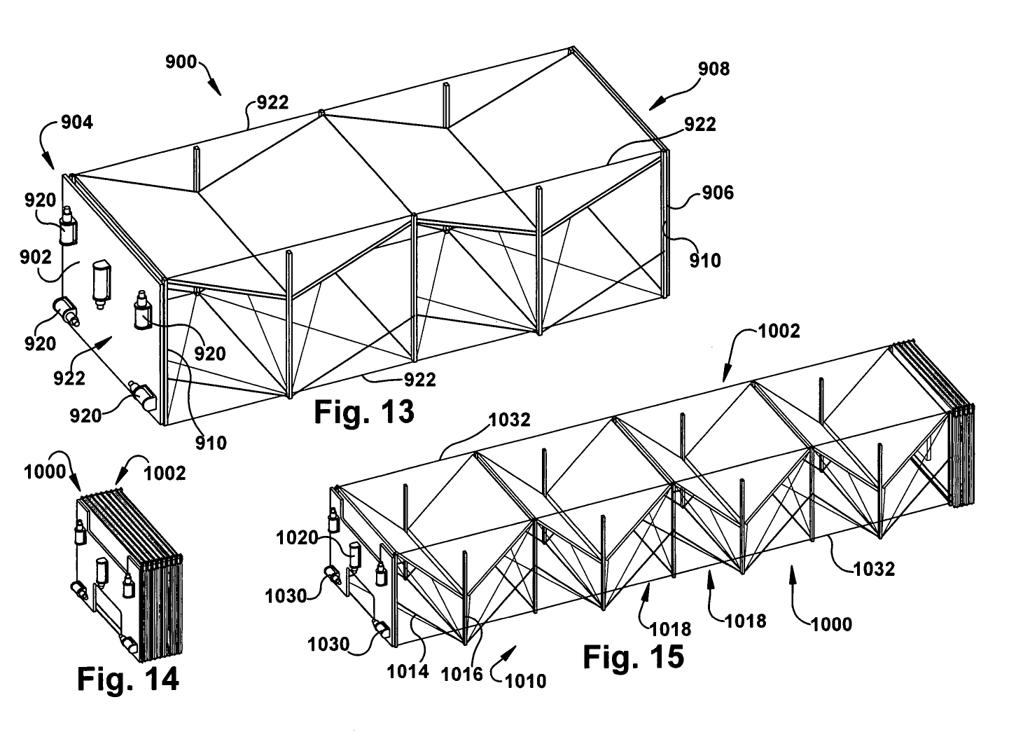

In accordance with another aspect of the invention, the truss structure can include at least one tension line or lanyard that controls the deployment rate of the truss structure and maintains stiffness in the truss structure throughout deployment. FIG. 13 is a perspective view of a partially deployed truss section 900 of a truss structure in accordance with another aspect of the invention that includes four lanyards. The truss section 900 in accordance with this aspect has a construction similar to the truss section illustrated in FIGS. 2 and 3. The truss section 900 also includes a first panel (or wall) 902 that defines a first end 904 of the truss section 900 and a second panel (or wall) 906 that defines a second end 908 of the truss section 900. The first panel 902 and the second panel 906 abut vertical supports 910 at opposite ends of the truss section 900. The first panel 902 and the second panel 906 have corners that correspond with upper and lower ends of the abutting vertical support members 910.

The first panel 902 includes four lanyard winding motors 920 that are positioned at opposite corners on a surface 922 of the first panel 902. Lanyards 922 extend from the winding spoolers 920 the length of the truss section 900 to the opposing corners on the second panel 906 of the truss section 900. Each lanyard 922 can be wound or unwound to maintain axial load on the truss section 900 during deployment. The stiffness of the partially deployed truss section can be maintained by differential tensioning of at least one lanyard 922 during deployment. Upon deployment, the lanyards 922 can also be differentially tensioned to provide the truss section 922 and the truss structure with a substantially linear shape.

In accordance with a further aspect of the invention, the truss structure of the panel array can be deployed synchronously so that each of the bays is deployed at the same time or sequentially so that a first plurality of bays of a first truss section of the truss structure deploys synchronously followed by a second plurality of bays of a second truss section of the truss structure. FIGS. 14-17 illustrate one technique that may be used to deploy a truss structure 1000 of a panel array 1002 in accordance with the present invention, such as a truss structure having a construction similar to the construction of the truss structure and in FIG. 13. Referring to FIG. 14, prior to deployment, a truss structure 1000 of a panel array 1002 is in collapsed configuration so that it can be stowed in a payload compartment of a launch vehicle (not shown) for transport into space.

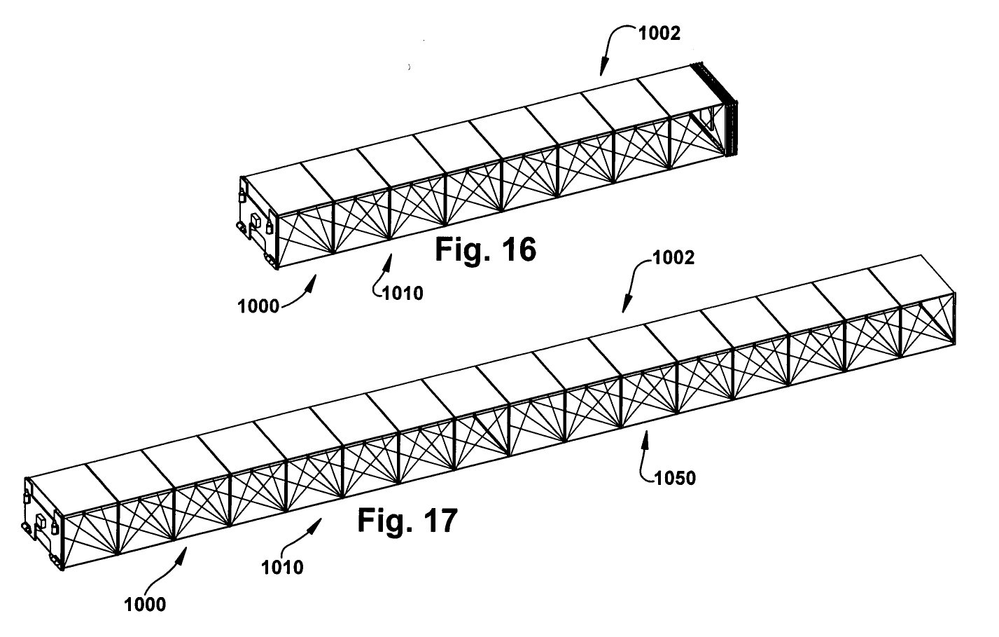

FIG. 15 illustrates that once the collapsed panel array 1002 is transported into space, a first truss section 1010 of the truss structure 1000 is partially deployed. The first truss section 1010 can be initially expanded from a collapsed configuration by, for example, release of a primary tie down (not shown), which maintains the first truss section 1010 in collapsed configuration, and expansion of kickoff springs (not shown), which provide initial separation of horizontal and vertical supports 1014 and 1016 that form the bays 1018. Following initial expansion, a deployment cable winding motor 1020 and lanyard winding motors 1030 are synchronously actuated by, for example, a satellite control system (not shown) to partially deploy the first truss section 1010. Actuation of the deployment cable winding motor 1020 causes the deployment cable (not shown) to be taken up so as to at least partially extend the bays 1018 in the first truss section 1010. The lanyard winding motor 1030 extends the lanyards 1032 synchronously to provide the required lanyard tension. The deployment winding motor 1020 continues to take up deployment cable and the lanyard winding motor 1030 continues to extend the lanyard 1032 until the first truss section 1010 of the truss 1000 structure of the panel array 1002 is fully deployed as illustrated in FIG. 16.

FIG. 17 illustrates that following deployment of the first truss section 1010, a second truss section 1050 is deployed by release of a secondary tie down (not shown), and further up take of the deployment cable and extension of the lanyards.

The deployed panel array 1002 can have, for example, a length of about 60 m to about 100 m when fully deployed and a width of about 2 to about 5 m. Each horizontal support member can have a length of about 3 m, each vertical support member can have a length of about 3 m, and each cross-support member can have a length of about 2 m to about 5 m.

It will be appreciated in accordance with the present invention, that the joints, pulleys, and associated structures may be formed from a variety of materials, such as materials with a low coefficient of thermal expansion (CTE). For example, the joints and pulleys may be formed from machined aluminum or titanium. Alternatively, the joints and pulleys may be formed using a graphite fiber or resin (e.g., molded). In addition, although the translating joints are implemented with wheels riding along rails, the translating joint may also be implemented using an outer tube structure that slides along an inner tube structure (e.g., a vertical support member). The region along which the sliding joint travels can be coated with a low friction surface such as TEFLON to reduce friction and binding propensity.

The truss structure provides a lightweight and inexpensive support structure for space-born reflectors that folds into a very compact volume. The present design is also much more cost effective to manufacture. The present design folds into a volume only one tenth the volume and only one quarter of the weight of previous designs, leading directly to significantly reduced cost to launch.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. A truss structure for a panel array comprising:
a plurality of deployed bays, each deployed bay including a first side and an opposing second side, each side of a deployed bay comprises a first upper horizontal support member and a second upper horizontal support member, the first upper horizontal support member being attached to a first vertical support member and collapsible on a first joint translating on a second vertical support member, the first lower horizontal support member being attached to the second vertical support member and collapsible on a second joint translating on the first vertical support member.

2. The truss structure of claim 1, the first side of the deployed bays being substantially parallel to the second side.

3. The truss structure of claim 2, each bay further comprising a plurality of substantially parallel cross-support members extending substantially orthogonal the vertical support members and the horizontal support members, the plurality of cross-support members connecting opposing sides of the bays.

4. The truss structure of claim 3, the cross-support members comprising a plurality of lower cross-support members, the plurality of lower cross-support connecting lower ends of vertical supports of the first side with lower ends of vertical supports in the second side.

5. The truss structure of claim 3, the cross-support members comprising a plurality of upper cross-support members, the upper cross-support members connecting upper horizontal support members of the first side with upper horizontal support members of the second side.

6. The truss structure of claim 5 the upper cross-support members supporting a plurality of panels.

7. The truss structure of claim 1, further comprising a third vertical support member, a second upper horizontal support member attached to the third vertical support member and collapsible on the first joint translating on the second vertical support member, and a second lower horizontal support member attached to the second vertical support member and collapsible on a third joint translating on the third vertical support member.

8. The truss structure of claim 7, the first vertical support member being shared between a first deployable bay adjacent to a second deployable bay, and the third vertical support member is shared between the second deployable bay and an adjacent third deployable bay, the first, second, and third deployable bays included in the plurality of deployable bays.

8. The truss structure of claim 5, each deployable bay comprising a telescoping strut connecting the first vertical support to the second vertical support, a first end of the telescoping strut being attached to an upper end of the first vertical support and a second end of the telescoping strut being connected to a lower end of the second vertical support.

9. The perimeter truss structure of claim 9, further comprising at least one deployment cable routed through the first upper horizontal support member and at least one synchronization cable routed through the first lower horizontal support member.

10. The perimeter truss structure of claim 9, further comprising at least one deployment cable routed astride the first upper horizontal support member and at least one synchronization cable routed astride the first lower horizontal support member.

11. A truss structure for a panel array comprising:
a plurality of deployed bays including a first side and an opposing second side, the first side and the second side of the deployed bays including at least first, second, and third vertical support members delineating a first bay and a second bay, the second vertical support member shared between the first bay and second bay,
the first bay including a first upper horizontal support member attached to the first vertical support member and collapsible on a first joint translating on the second vertical support member and a first lower horizontal support member attached to the second vertical support member and collapsible on a second joint translating on the first vertical support member;
the second bay including a second upper horizontal support member attached to the third vertical support member and collapsible on the first joint translating on the second vertical support member and a second lower horizontal support member attached to the second vertical support member and collapsible on a third joint translating on the third vertical support member.

12. The truss structure of claim 11, the first side extending substantially parallel to the second side.

13. The truss structure of claim 11, the bays further comprising a plurality of substantially parallel cross-support members extending substantially orthogonal the vertical support members and the horizontal support members, the plurality of cross-support members connecting opposing sides of the bays.

14. The truss structure of claim 13, the cross-support members comprising a plurality of lower cross-support members, the plurality of lower cross-support connecting lower ends of vertical supports of the first side with lower ends of vertical supports of the second side.

15. The truss structure of claim 13, the cross-support members comprising a plurality of upper cross-support members, the upper cross-support members connecting upper horizontal support members of the first side with upper horizontal support members of the second side.

16. The truss structure of claim 15 the upper cross-support members supporting a plurality of panels.

17. The truss structure of claim 15, the first deployable bay comprising a first telescoping strut connecting the first vertical support member to the second vertical support, a first end of the telescoping strut being attached to an upper end of the first vertical support and a second end of the telescoping strut being connected to a lower end of the second vertical support.

18. The truss structure of claim 17, the second deployable bay comprising a telescoping strut connecting the second vertical support to the third vertical support, a first end of the second telescoping strut being attached to a lower end of the second vertical support and a second end of the second telescoping strut being connected to a upper end of the third vertical support.

19. The truss structure of claim 11, further comprising a first and second pulleys riding with the first joint, a third pulley at a first end of the second vertical support member, a fourth pulley at a first end of the third vertical support member, and a fifth pulley at a first end of the first vertical support member; a deployment cable running over the third, fourth, and fifth pulleys and under the first and second pulleys; and a winding motor for pulling in the deployment cable to lift the first joint into a deployed position

20. The truss structure of claim 19, further comprising a sixth pulley riding with the second joint, seventh and eighth pulleys adjacent to a second end of the second vertical support member, and a ninth pulley riding with the third joint.

21. The truss structure of claim 20, wherein the first and second horizontal support members are hollow, and the deployment cable runs inside the first and second horizontal support members.

22. The truss structure of claim 26, wherein at least one of the first, second, and third joints comprises a trolley for translational motion.

23. The truss structure of claim 22, wherein the trolley comprises wheels riding on at least first and second tracks along the length of at least one of the first, second, and third vertical support members.

24. The truss structure of claim 19, further comprising at least one lanyard for maintaining the bays in tension during deployment.

25. The truss structure of claim 24 the lanyard extending the length of each side.

26. A truss structure for a panel array comprising:
a plurality of deployed bays including a first side and an opposing second side, the first side and the second side of the deployed bays including at least first, second, and third vertical support members delineating a first bay and a second bay, the second vertical support member shared between the first bay and second bay,
the first bay including a first upper horizontal support member attached to the first vertical support member and collapsible on a first joint translating on the second vertical support member and a first lower horizontal support member attached to the second vertical support member and collapsible on a second joint translating on the first vertical support member;
the second bay including a second upper horizontal support member attached to the third vertical support member and collapsible on the first joint translating on the second vertical support member and a second lower horizontal support member attached to the second vertical support member and collapsible on a third joint translating on the third vertical support member; and
a plurality of substantially parallel cross-support members extending substantially orthogonal the vertical support members and the horizontal support members, the plurality of cross-support members connecting opposing sides of the bays.

27. The truss structure of claim 26, the cross-support members comprising a plurality of lower cross-support members, the plurality of lower cross-support connecting lower ends of vertical supports of the first side with lower ends of vertical supports in the second side.

28. The truss structure of claim 27, further comprising a first and second pulleys riding with the first joint, a third pulley at a first end of the second vertical support member, a fourth pulley at a first end of the third vertical support member, and a fifth pulley at a first end of the first vertical support member; a deployment cable running over the third, fourth, and fifth pulleys and under the first and second pulleys; and a winding motor for pulling in the deployment cable to lift the first joint into a deployed position

29. The truss structure of claim 28, further comprising a sixth pulley riding with the second joint, seventh and eighth pulleys adjacent to a second end of the second vertical support member, and a ninth pulley riding with the third joint.

30. The truss structure of claim 26, wherein the first and second horizontal support members are hollow, and the deployment cable runs inside the first and second horizontal support members.

31. The truss structure of claim 30, wherein at least one of the first, second, and third joints comprises a trolley for translational motion.

32. The truss structure of claim 19, further comprising at least one lanyard for maintaining the bays in tension during deployment.

33. The truss structure of claim 24 the lanyard extending the length of each side.
